(19) United States
(12) Patent Application Publication
(10) Pub. No.: US 2022/0262579 A1
(43) Pub. Date: Aug. 18, 2022

(54) SWITCHING COMPONENT COMPRISING MOVEABLE CARRIER AND MOVEABLE CONTACTS ATTACHED THERETO

(71) Applicant: HONEYWELL INTERNATIONAL INC., Charlotte, NC (US)

(72) Inventors: Yin WEI, Charlotte, NC (US); Houyong WANG, Charlotte, NC (US); Jie RAO, Charlotte, NC (US); Fan YANG, Charlotte, NC (US); Yu HU, Charlotte, NC (US)

(21) Appl. No.: 17/644,996

(22) Filed: Dec. 17, 2021

(30) Foreign Application Priority Data
Feb. 18, 2021 (CN) 202110187261.9

(51) Int. Cl. H01H 1/14; H01H 9/02

(52) U.S. Cl. CPC H01H 1/14; H01H 9/02

(57) ABSTRACT

Methods, apparatuses and systems for providing a switching component are disclosed herein. An example switching component may include: a housing, a moveable carrier disposed within the housing, a set of moveable contacts, wherein a central body of the set of moveable contacts is disposed flush between a first surface of the moveable carrier and a second surface of the moveable carrier, and a set of stationary contacts adjacent the set of moveable contacts, wherein the set of moveable contacts is configured to move with a degree of freedom to make contact with the set of stationary contacts in order to actuate an electrical bridge in response to movement of the moveable carrier.

### CROSS-REFERENCE TO RELATED APPLICATIONS

This application claims priority pursuant to 35 U.S.C. 119(a) to Chinese Patent Application No. 202110187261.9, filed Feb. 18, 2021, which application is incorporated herein by reference in its entirety.

### BACKGROUND

Switching components comprising moveable carriers and moveable contacts may be used in conjunction with a variety of electrical devices, circuits and systems. An example moveable contact may be attached to a moveable carrier such that it can move to make contact with a stationary contact in order to actuate an electrical bridge/terminal. Such switching components are plagued by technical challenges and limitations. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to methods, apparatuses, and systems for providing a switching component.

In accordance with various examples of the present disclosure, a switching component is provided. The switching component may comprise: a housing; a moveable carrier disposed within the housing; a set of moveable contacts, wherein a central body of the set of moveable contacts is disposed flush between a first surface of the moveable carrier and a second surface of the moveable carrier; and a set of stationary contacts adjacent the set of moveable contacts, wherein the set of moveable contacts is configured to move with a degree of freedom to make contact with the set of stationary contacts in order to actuate an electrical bridge in response to movement of the moveable carrier.

In accordance with various examples of the present disclosure, another switching component is provided. The switching component may comprise: a housing; a moveable carrier disposed within the housing; a first set of moveable contacts, a second set of moveable contacts, a third set of moveable contacts and a fourth set of moveable contacts, wherein a central body of each set of moveable contacts is disposed flush between a first surface of the moveable carrier and a second surface of the moveable carrier; and a first set of stationary contacts adjacent the first set of moveable contacts, a second set of stationary contacts adjacent the second set of moveable contacts, a third set of stationary contacts adjacent the third set of moveable contacts and a fourth set of stationary contacts adjacent the fourth set of moveable contacts, wherein each set of moveable contacts is configured to move with a degree of freedom to make contact with each adjacent set of stationary contacts in order to actuate an electrical bridge in response to movement of the moveable carrier.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example switching component in accordance with various embodiments of the present disclosure;

FIG. 2 illustrates an example moveable carrier assembly in accordance with various embodiments of the present disclosure;

FIG. 3 illustrates an example set of moveable contacts in accordance with various embodiments of the present disclosure;

FIG. 4 illustrates an example securing element of a moveable carrier in accordance with various embodiments of the present disclosure;

FIG. 5 illustrates an example set of moveable contacts and a securing element in accordance with various embodiments of the present disclosure; and

FIG. 6 illustrates a side view of an example set of moveable contacts and a securing element in accordance with various embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

The phrases “in an example embodiment,” “some embodiments,” “various embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such components or features may be optionally included in some embodiments, or may be excluded.

The terms “electronically coupled” or “in electronic communication with” in the present disclosure refer to two or more electrical elements (for example, but not limited to, an example processing circuitry, communication module, input/output module, memory, switching component) and/or electric circuit(s) being connected through wired means (for example but not limited to, conductive wires or traces) and/or wireless means (for example but not limited to, wireless network, electromagnetic field), such that electronic indications, signal or the like data and/or information (for example, electronic indications, signals) may be transmitted to and/or received from the electrical elements and/or electric circuit(s) that are electronically coupled.

The term “switching component” may refer to an electrical component or electromechanical device that can be configured to connect or disconnect a conducting path in an electrical circuit such that electrical current flowing along the conducting path is interrupted or diverted. Switching components may be used in a variety of applications to control electrical circuits. Switching components may comprise one or more moveable contacts and one or more stationary contacts. In various applications, when a moveable contact and corresponding/adjacent stationary contact are in a closed state (i.e., make contact with one another), an electrical terminal/bridge is actuated such that electrical current can pass between them. In contrast, when a moveable contact and corresponding/adjacent stationary contact are in an open state (i.e., not in contact with one another), no electrical current passes between them.

A moveable contact may be configured to move (e.g., wobble, rotate, swing) relative to a corresponding/adjacent stationary contact such that an electrical connection can be formed between them. An example switching component may comprise one or more moveable contacts attached to a moveable contact carrier such that the moveable contact(s) can move with a degree of freedom (e.g., up-and-down with respect to a corresponding/adjacent stationary contact(s)) in order to form an electrical connection with the corresponding/adjacent stationary contact(s).

In some examples, misalignment between a moveable contact and a corresponding/adjacent stationary contact may result in electrical arcing or a failure to form a proper electrical connection between the moveable contact and the stationary contact. Accordingly, a switching component may comprise a set of moveable contacts comprising more than one contact pad in order to provide design redundancy. For example, a set of moveable contacts comprising two contact pads may be positioned adjacent a set of stationary contacts comprising two corresponding/adjacent contact pads such that each respective pair of contact pads makes contact in order to actuate an electrical terminal/bridge.

In general, a moveable contact comprising more than one contact pad may be fabricated with a gap between the body or structure of the moveable contact and the moveable carrier to which it is attached/secured such that the moveable contact and contact pads disposed thereon are able to move with a degree of freedom relative to corresponding/adjacent stationary contacts in order to form an electrical connection. However, in such examples, the presence of a gap between the body/structure of the moveable contact and the moveable carrier (e.g., between a surface of the moveable contact and an adjacent surface of the moveable carrier) may result in improper functioning under the influence of gravity. For example, if a moveable contact is not oriented in an upright position within a system, the moveable contact and corresponding/adjacent stationary contact may fail to make a proper electrical connection during operations and over the course of the electrical service life of the switching component. Additionally, existing switching components may be expensive to produce and difficult to fabricate due at least in part to the required gap between the body/structure of the moveable contact and the moveable carrier.

In accordance with various embodiments of the present disclosure, example methods, apparatuses and systems are provided. In various embodiments, the present disclosure may provide a switching component comprising a housing, a moveable carrier disposed within the housing, at least one set of moveable contacts, wherein a central body of the at least one set of moveable contacts is disposed flush between a first surface of the moveable carrier and a second surface of the moveable carrier, and at least one set of stationary contacts adjacent the at least one set of moveable contacts, wherein the at least one set of moveable contacts is configured to move with a degree of freedom to make contact with the at least one set of stationary contacts in order to actuate an electrical bridge in response to movement of the moveable carrier.

The example switching component may be configured as a double pole double throw switch. In some examples, the at least one set of moveable contacts is attached to the moveable carrier via a securing element. In some examples, the central body of the at least one set of moveable contacts comprises an arched configuration having a semi-circular space therebeneath. In some examples, the at least one securing element comprises an extension member and a support member. In some examples, the at least one set of moveable contacts is disposed between the extension member and the support member. In some examples, the support member comprises a half-cylindrical structure configured to complement a space beneath the at least one set of moveable contacts. The example extension member may comprise a hook-like appendage protruding from a surface of the moveable carrier. The example extension member may further comprises a notch to secure the at least one set of moveable contacts to the moveable carrier. The example set of stationary contacts may comprise a first contact pad and a second contact pad. The example set of moveable contacts may comprise a third contact pad adjacent the first contact pad and a fourth contact pad adjacent the second contact pad. The example set of stationary contacts may be fixedly attached to a bridge element of the switching component.

Using the apparatuses and techniques disclosed herein, the electrical service life of an example switching component can be increased, in some examples, from 500,000 operations to, in some examples, over 1,500,000. Additionally, the example switching component will function optimally when configured in any position within a system and will not be affected by gravity. By way of example, as a result of a central body of an example set of moveable contacts being disposed flush between a first surface of a moveable carrier and a second surface of the moveable carrier, the motion of the moveable contacts in relation to the stationary contacts will not be affected by any conceivable orientation of the switching component. Further, the example switching component of the present disclosure is less complex and inexpensive to produce in comparison to existing devices.

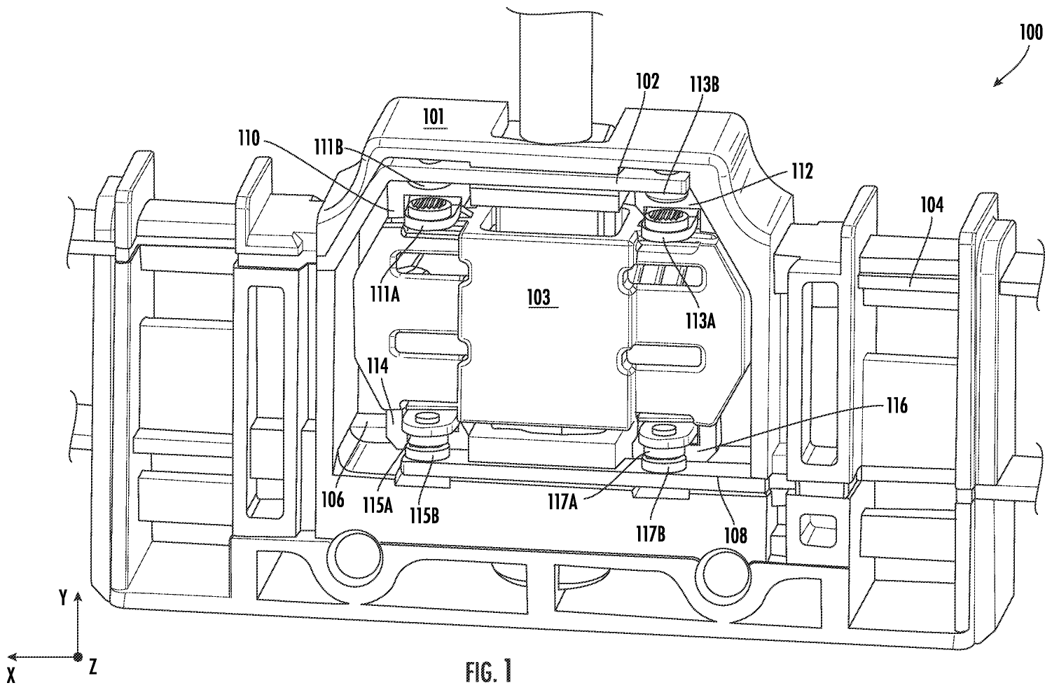

Referring now to FIG. 1, an example schematic diagram depicts an example switching component 100 in accordance with various embodiments of the present disclosure. In particular, the example switching component 100 comprises a housing 101, a moveable carrier 103, a first set of moveable contacts 111A and corresponding/adjacent stationary contacts 111B, a second set of moveable contacts 113A and corresponding/adjacent stationary contacts 113B, a third set of moveable contacts 115A and corresponding/adjacent stationary contacts 115B, a fourth set of moveable contacts 117A and corresponding/adjacent stationary contacts 117B, a first bridge element 102, a second bridge element 104, a third bridge element 106, a fourth bridge element 108, a first securing element 110, a second securing element 112, a third securing element 114 and a fourth securing element 116. The example switching component 100 may be a component of an electrical system and/or in wired communication with other electrical components and/or devices.

As depicted in FIG. 1, the switching component 100 comprises a housing 101. The example housing 101 may comprise metal, plastic, combinations thereof, and/or the like. In various embodiments, the moveable carrier 103 may be arranged, contained, or disposed partially or completely within the housing 101 of the switching component 100. For example, as shown, the moveable carrier 103 is disposed within the housing 101 of the switching component 100.

Similarly, as depicted, the first set of moveable contacts 111A and corresponding/adjacent stationary contacts 111B, the second set of moveable contacts 113A and corresponding/adjacent stationary contacts 113B, the third set of moveable contacts 115A and corresponding/adjacent stationary contacts 115B and the fourth set of moveable contacts 117A and corresponding/adjacent stationary contacts 117B are disposed within the housing 101 of the switching component 100.

As depicted in FIG. 1, the example switching component 100 comprises a moveable carrier 103 configured to move within the housing 101 such that one or more sets of moveable contacts and stationary contacts make contact in order to actuate an electrical terminal/bridge. In some examples, the moveable carrier 103 may comprise an insulating material such as plastic. In various embodiments, the moveable carrier 103 may comprise a moveable armature and a spring to facilitate movement of the moveable carrier 103. For example, the moveable carrier 103 may be configured to move vertically within the housing 101 of the switching component 100.

As depicted, the moveable carrier 103 is configured to move vertically within the housing 101 (e.g., in a y-direction) such that the first set of moveable contacts 111A and the second set of moveable contacts 113A disposed on a top portion of the moveable carrier 103 make contact with respective stationary contacts 111B and 113B in order to actuate an electrical terminal/bridge (e.g., the first bridge element 102 and the second bridge element 104). The moveable carrier 103 is configured to move within the housing 101 (e.g., in the y-direction) such that the third set of moveable contacts 115A and the fourth set of moveable contacts 117A disposed on a bottom portion of the moveable carrier 103 make contact with respective stationary contacts 115B and 117B in order to actuate an electrical terminal/bridge (e.g., the third bridge element 106 and the fourth bridge element 108).

As depicted in FIG. 1, the first set of moveable contacts 111A is attached to a top portion of the moveable carrier 103 via a first securing element 110 of the moveable carrier 103. As further depicted, the second set of moveable contacts 113A is attached to a top portion of the moveable carrier 103 via a second securing element 112 of the moveable carrier 103. As shown, the third set of moveable contacts 115A is attached to a bottom portion of the of the moveable carrier 103 via a third securing element 114. Similarly, the fourth set of moveable contacts 117A is attached to a bottom portion of the moveable carrier 103 via a fourth securing element 116.

As noted above, each set of moveable contacts 111A, 113A, 115A and 117A may be positioned adjacent a respective set of stationary contacts 111B, 113B, 115B and 117B. As depicted in FIG. 1, each set of respective stationary contacts 111B, 113B, 115B and 117B may be fixedly attached to a surface of the switching component 100. In various embodiments, each set of moveable contacts 111A, 113A, 115A and 117A may comprise a plurality of contact pads (e.g., two contact pads). Similarly, each set of respective stationary contacts 111B, 113B, 115B and 117B may comprise a plurality of corresponding contact pads (e.g., two contact pads).

As noted above, the switching component 100 comprises a first bridge element 102, a second bridge element 104, a third bridge element 106 and a fourth bridge element 108. In some examples, each bridge element 102, 104, 106 and 108 may be or comprise a substantially planar conductive metal substrate. For example, each bridge element 102, 104, 106 and 108 may comprise, silver, nickel, copper, cadmium oxide, tin oxide, combinations thereof, and/or the like. Each bridge element 102, 104, 106 and 108 may be in wired communication with/electrically connected to other elements, components and/or devices within an electrical circuit/system.

As depicted in FIG. 1, the first set of stationary contacts 111B comprises at least a first contact pad fixedly attached to the first bridge element 102 of the switching component 100. Similarly, the second set of stationary contacts 113B comprises at least a first contact pad fixedly attached to the first bridge element 202 of the switching component 100. As shown, the third set of stationary contacts 115B comprises at least a first contact pad fixedly attached to the fourth bridge element 108 of the switching component 100. Similarly, the fourth set of stationary contacts 117B comprises at least a first contact pad fixedly attached to the fourth bridge element 108 of the switching component 100.

While some of the embodiments herein provide an example switching component 100, it is noted that the scope of the present disclosure is not limited to such embodiments. For example, in some examples, a switching component 100 in accordance with the present disclosure may be in other forms. In some examples, an example switching component 100 may comprise one or more additional and/or alternative elements, and/or may be structured/positioned differently than that illustrated in FIG. 1.

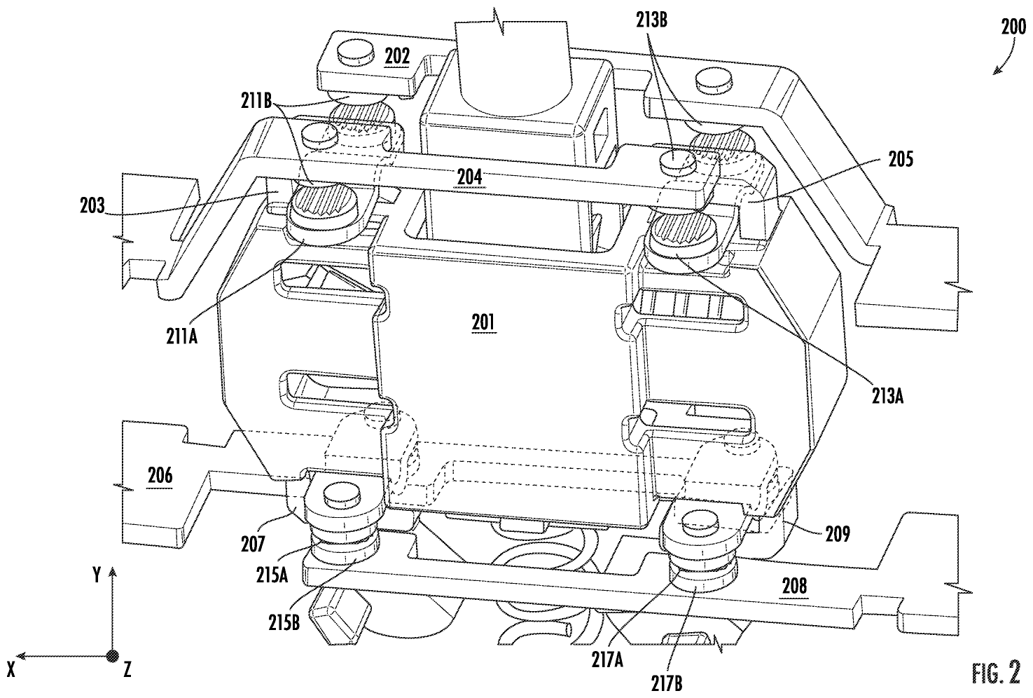

Referring now to FIG. 2, an example schematic diagram depicting an example moveable carrier assembly 200 in accordance with various embodiments of the present disclosure is provided. As depicted, the moveable carrier assembly 200 comprises a first set of moveable contacts 211A and corresponding/adjacent stationary contacts 211B, a second set of moveable contacts 213A and corresponding/adjacent stationary contacts 213B, a third set of moveable contacts 215A and corresponding/adjacent stationary contacts 215B, a fourth set of moveable contacts 217A and corresponding/adjacent stationary contacts 217B, a first bridge element 202, a second bridge element 204, and third bridge element 206, a fourth bridge element 208, a first securing element 203, a second securing element 205, a third securing element 207 and a fourth securing element 209. The example moveable carrier assembly 200 may be at least partially disposed within a housing of an example switching component.

As noted above in connection with FIG. 1, the moveable carrier 201 is configured to move vertically (e.g., in a y-direction) within a housing of an example switching component. As depicted in FIG. 2, the moveable carrier 201 is configured to move within a housing such that the one or more sets of moveable contacts 211A, 213A, 215A and 217A and corresponding/adjacent sets of stationary contacts 211B, 213B, 215B and 217B make contact in order to actuate an electrical terminal/bridge (e.g., the first bridge element 202, the second bridge element 204, the third bridge element 206 and/or the fourth bridge element 208).

As shown, the example moveable carrier assembly 200 comprises a first set of moveable contacts 211A and a second set of moveable contacts 213A, each disposed/attached to a top portion of the moveable carrier 201. Additionally, as depicted, the moveable carrier assembly 200 comprises a third set of moveable contacts 215A and a fourth set of moveable contacts 217A each disposed/attached to a bottom portion of the moveable carrier 201. The example moveable carrier assembly 200 further comprises a first set of stationary contacts 211B disposed adjacent to and positioned directly above the first set of moveable contacts 211A. The example moveable carrier assembly 200 comprises a second set of stationary contacts 213B disposed adjacent to and positioned directly above the second set of moveable contacts 213A. As shown, the example moveable carrier assembly 200 comprises a third set of stationary contacts 215B disposed adjacent to and directly below the third set of moveable contacts 215A. Additionally, the example moveable carrier assembly 200 comprises a fourth set of stationary contacts 217B disposed adjacent to and directly below the fourth set of moveable contacts 217A.

As noted above, the moveable carrier 201 is configured to move vertically within a housing (e.g., in a y-direction) such that the first set of moveable contacts 211A and the second set of moveable contacts 213A disposed on the top portion of the moveable carrier 201 make contact with respective stationary contacts 211B and 213B in order to actuate an electrical terminal/bridge (e.g., the first bridge element 202 and the second bridge element 204). The moveable carrier 201 is configured to move within the housing (e.g., in the y-direction) such that the third set of moveable contacts 215A and the fourth set of moveable contacts 217A disposed on the bottom portion of the moveable carrier 201 make contact with respective stationary contacts 215B and 217B in order to actuate an electrical terminal/bridge (e.g., the third bridge element 206 and the fourth bridge element 208).

As depicted in FIG. 2, the first set of moveable contacts 211A is attached to a top portion of the moveable carrier 201 via a first securing element 203 of the moveable carrier 201. As further depicted, the second set of moveable contacts 213A is attached to a top portion of the moveable carrier 201 via a second securing element 205 of the moveable carrier 201. As shown, the third set of moveable contacts 215A is attached to a bottom portion of the of the moveable carrier 201 via a third securing element 207. Similarly, the fourth set of moveable contacts 217A is attached to a bottom portion of the moveable carrier 201 via a fourth securing element 209.

As noted above, each set of moveable contacts 211A, 213A, 215A and 217A may be positioned adjacent a respective set of stationary contacts 211B, 213B, 215B and 217B. As depicted in FIG. 2, each set of respective stationary contacts 211B, 213B, 215B and 217B may be fixedly attached to a portion or component of the moveable carrier assembly 200/switching component. As depicted, each set of stationary contacts 211B, 213B, 215B and 217B comprises two distinct contact pads, each attached to an element/component of the moveable carrier assembly 200. In some examples, a set of stationary contacts 211B, 213B, 215B and 217B and/or moveable contacts 211A, 213A, 215A and 217A may each comprise more than two contact pads. For example, a set of stationary contacts and/or moveable contacts may each comprise three contact pads. Each contact pad may comprise a substantially circular conductive metal material. In various examples, an example contact pad of a set of stationary contacts 211B, 213B, 215B and 217B may be identical and/or similar to the contact pads of a corresponding/adjacent set of moveable contacts 211A, 213A, 215A and 217A. A contact pad may comprise, for example, without limitation, silver, nickel, copper, cadmium oxide, tin oxide, combinations thereof, and/or the like.

As depicted in FIG. 2, the first set of stationary contacts 211B comprises a first contact pad fixedly attached to the first bridge element 202 and a second contact pad fixedly attached to the second bridge element 204 of the moveable carrier assembly 200. Similarly, the second set of stationary contacts 213B comprises a first contact pad fixedly attached to the first bridge element 202 and a second contact pad fixedly attached to the second bridge element 204 of the moveable carrier assembly 200. As shown, the third set of stationary contacts 215B comprises a first contact pad fixedly attached to the third bridge element 206 and a second contact pad fixedly attached to the fourth bridge element 208 of the moveable carrier assembly 200. Similarly, the fourth set of stationary contacts 217B comprises a first contact pad fixedly attached to the third bridge element 206 and a second contact pad fixedly attached to the fourth bridge element 208 of the moveable carrier assembly 200. As noted above, each of the first bridge element 202, second bridge element 204, third bridge element 206 and fourth bridge element 208 may be or comprise a substantially planar conductive metal substrate in wired communication with/electrically connected to other elements, components and/or devices within an electrical circuit/system.

While some of the embodiments herein provide an example moveable carrier assembly 200, it is noted that the scope of the present disclosure is not limited to such embodiments. For example, in some examples, a moveable carrier assembly 200 in accordance with the present disclosure may be in other forms. In some examples, a moveable carrier assembly 200 may comprise one or more additional and/or alternative elements, and/or may be structured/positioned differently than that illustrated in FIG. 2.

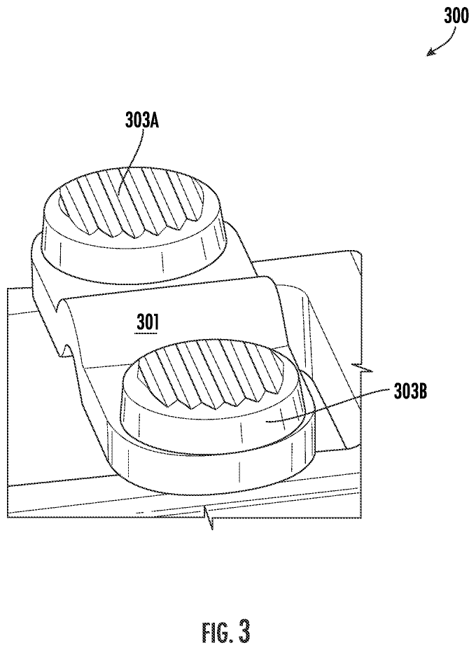

Referring now to FIG. 3, an example schematic diagram depicting an example set of moveable contacts 300 is provided.

As depicted in FIG. 3, the example set of moveable contacts 300 comprises a body 301, a first contact pad 303A and a second contact pad 303B.

As depicted in FIG. 3, the body 301 of the set of moveable contacts 300 comprises a substantially planar elliptical body. The body 301 of the set of moveable contacts 300 may be or comprise a metallic material (e.g., copper, brass, and/or the like). As shown, a central portion of the body 301 of the set of moveable contacts 300 comprises an arched configuration having a semi-circular space therebeneath.

As depicted in FIG. 3, the set of moveable contacts comprises a first contact pad 303A and a second contact pad 303B. As depicted, the example first contact pad 303A and second contact pad 303B may be or comprise identical circular shaped pads. Each of the first contact pad 303A and the second contact pad 303B may comprise for example, without limitation, silver, nickel, copper, cadmium oxide, tin oxide, combinations thereof, and/or the like.

As depicted in FIG. 3, the first contact pad 303A is disposed on a first end of a top surface of the body 301 of the set of moveable contacts 300. Similarly, the second contact pad 303B is disposed on a second end of the top surface of the body 301 of the set of moveable contacts, opposite the first contact pad 303A. As noted above in relation to FIG. 2, the first contact pad 303A and the second contact pad 303B of the set of moveable contacts 300 are configured to allow the set of moveable contacts 300 to move freely in a y-direction (e.g., up and down) with respect to the moveable carrier/switching component housing.

While some of the embodiments herein provide an example set of moveable contacts 300, it is noted that the scope of the present disclosure is not limited to such embodiments. For example, in some examples, a set of moveable contacts 300 in accordance with the present disclosure may be in other forms. In some examples, a set of moveable contacts 300 may comprise one or more additional and/or alternative elements, and/or may be structured/positioned differently than that illustrated in FIG. 3.

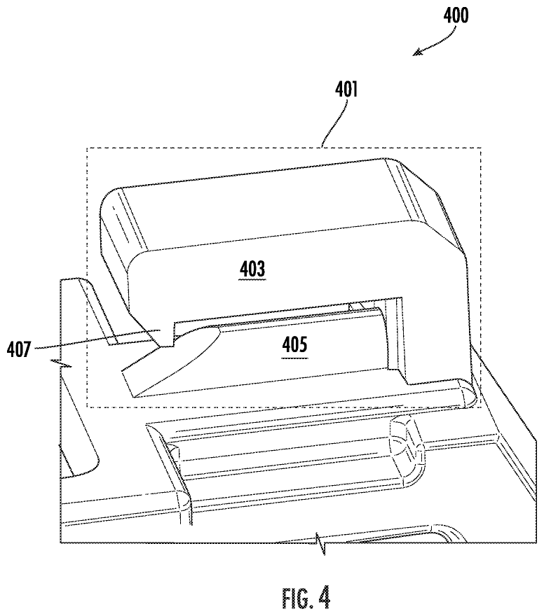

Referring now to FIG. 4, an example schematic diagram depicting a securing element 401 of an example moveable carrier 400 is provided.

As depicted in FIG. 4, the securing element 401 comprises an extension member 403 and a support member 405 configured to receive and secure a set of moveable contacts therebetween. In some examples, the securing element 401 and the moveable carrier 400 may define a unitary body and be comprised of the same material. For example, the securing element 401 and/or moveable carrier 400 may be or comprise a plastic material.

In various embodiments, the securing element 401 may be disposed on a surface of the example moveable carrier 400 (e.g., a top surface of the moveable carrier 400 or bottom surface of the moveable carrier 400). As depicted, the example securing element 401 is disposed on a top surface of the moveable carrier 400.

As depicted in FIG. 4, the securing element 401 comprises an extension member 403. As shown, the extension member 403 comprises a hook-like appendage protruding from a surface of an example moveable carrier 400 and defining a top portion of the securing element 401. The extension member 403 is positioned to restrain a central portion of the set of moveable contacts such that the set of moveable contacts can move with a degree of freedom. As further depicted, the extension member 403 includes a notch 407 to prevent the body of a set of moveable contacts from moving laterally out of a secure position.

As depicted in FIG. 4, the securing element 401 comprises a support member 405. As depicted, the support member 405 comprises a half-cylindrical structure defining a bottom portion of the securing element 401. In various examples, the structure of the support member 405 is configured to be complementary to the structure of the body of the set of moveable contacts (e.g., the set of moveable contacts described in connection with FIG. 3.) The securing element 401 is configured to slidably receive and secure a set of moveable contacts such that the contact pads thereon can move with a degree of freedom (e.g., in a y-direction). The example set of moveable contacts is configured to be disposed flush between a bottom surface of the extension member 403 and a top surface of the support member 405 when secured therebetween. Said differently, the central body of the example moveable contacts is disposed between the extension member 403 and the support member 405 such that there is substantially no gap between the extension member 403, a central body of the example set of moveable contacts and a top surface of the support member 405. By way of example, a gap between a bottom surface of the extension member 403 and a top surface of the central body of the example set of moveable contacts may be less than 0.5 mm. Similarly, a gap between a bottom surface of the central body of the example set of moveable contacts and a top surface of the support member 405 may be less than 0.5 mm.

While some of the embodiments herein provide an example securing element 401, it is noted that the scope of the present disclosure is not limited to such embodiments. For example, in some examples, a securing element 401 in accordance with the present disclosure may be in other forms. In some examples, a securing element 401 may comprise one or more additional and/or alternative elements, and/or may be structured/positioned differently than that illustrated in FIG. 4. For example, as depicted in FIG. 2, discussed above, the securing element, may be disposed on a bottom surface of moveable carrier such that the support member defines the top portion of the securing element and the extension member defines the bottom portion of the securing element.

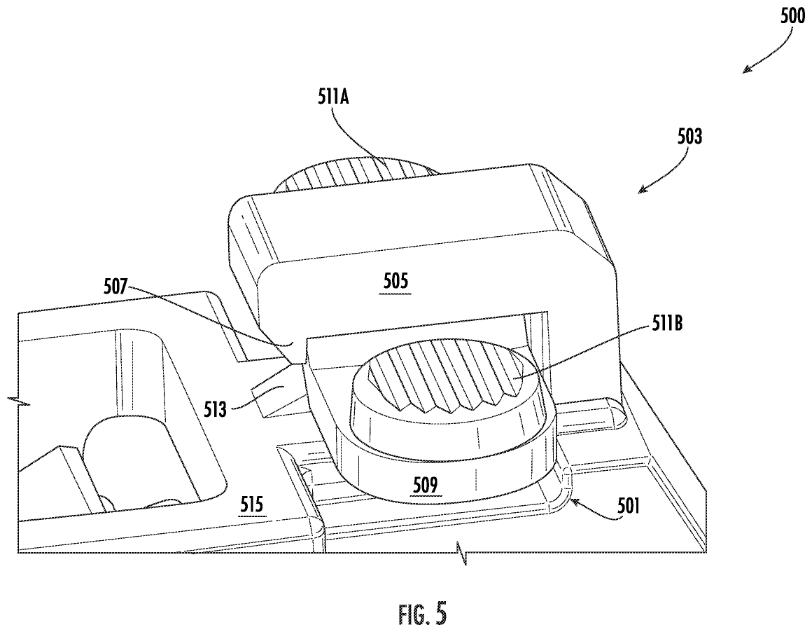

Referring now to FIG. 5, an example schematic diagram 500 depicting an example set of moveable contacts 501 and a securing element 503 is provided.

As depicted in FIG. 5, the securing element 503 comprises an extension member 505 and a support member 507 configured to receive and secure a set of moveable contacts 501 therebetween.

In various examples, the securing element 503 is disposed on a surface of an example moveable carrier 515. As depicted, the example securing element 503 is disposed on a top surface of the example moveable carrier 515.

As noted above, and as depicted in FIG. 5, the securing element 503 comprises an extension member 505. As shown, the extension member 505 comprises a hook-like appendage protruding from a top surface of the example moveable carrier 515 and defining a top portion of the securing element 503. The extension member 505 is positioned to restrain a central portion of the set of moveable contacts 501 such that the set of moveable contacts 501, and contact pads 511A and 511B disposed thereon, can move with a degree of freedom. As further depicted, the extension member 505 includes a notch 507 to prevent the body 509 of a set of moveable contacts 501 from moving laterally out of a secure position.

As depicted in FIG. 5, the securing element 503 comprises a support member 513. The securing element 503 is configured to slidably receive and secure the set of moveable contacts 501 such that the contact pads 511A and 511B disposed thereon can move with a degree of freedom (e.g., in a y-direction). As shown, the support member 513 comprises a half-cylindrical structure defining a bottom portion of the securing element 503. As depicted, the structure of the support member 513 is configured to be complementary to the structure of the body 509 of the set of moveable contacts 501. As depicted, a central body 509 of the set of moveable contacts 501 is configured to be disposed between the extension member 505 and the support member 513 when secured therebetween such that the central body 509 of the moveable contacts 501 is disposed flush between a bottom surface of the extension member 503 and a top surface of the support member 513.

While some of the embodiments herein provide an example set of moveable contacts 501 and a securing element 503, it is noted that the scope of the present disclosure is not limited to such embodiments. For example, in some examples, a set of moveable contacts 501 and a securing element 503 in accordance with the present disclosure may be in other forms. In some examples, set of moveable contacts 501 and a securing element 503 may comprise one or more additional and/or alternative elements, and/or may be structured/positioned differently than that illustrated in FIG. 5.

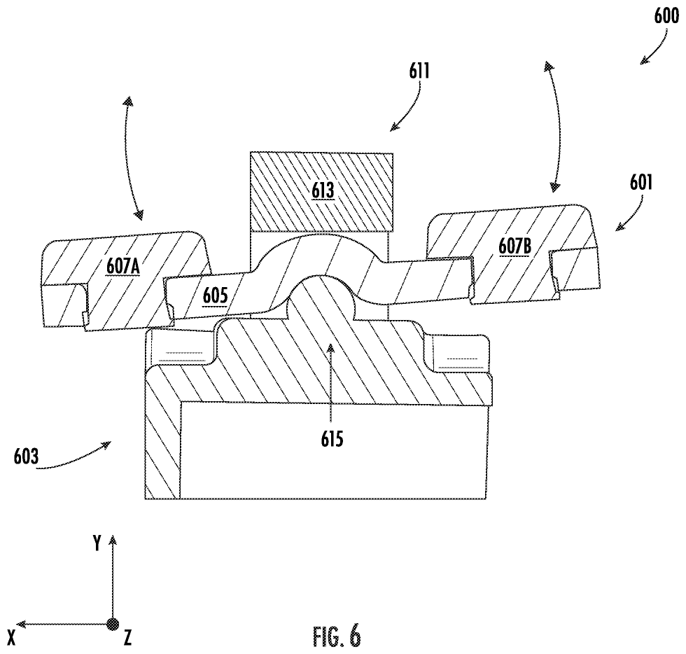

Referring now to FIG. 6, an example schematic diagram 600 depicting a side view of an example set of moveable contacts 601 and a securing element 611 is provided.

As depicted in FIG. 6, the securing element 611 comprises an extension member 613 and a support member 615 configured to receive and secure a set of moveable contacts 601 therebetween.

In various examples, as depicted, the securing element 611 is disposed on a surface of an example moveable carrier 603. As depicted, the example securing element 503 is disposed on a top surface of the example moveable carrier 603.

As depicted in FIG. 6, the securing element 611 comprises an extension member 613. As shown, the extension member 613 comprises a hook-like appendage protruding from a top surface of the example moveable carrier 603 and defining a top portion of the securing element 503. The extension member 613 is positioned to restrain a central portion of a body 605 of the set of moveable contacts 601 such that the set of moveable contacts 601, and contact pads 607A and 607B disposed thereon, can move with a degree of freedom. The extension member 613 may include notches, grooves, clips and or the like to prevent the body 605 of the set of moveable contacts 601 from moving or sliding laterally out of a secure position.

As noted above, and as depicted in FIG. 6, the securing element 611 comprises a support member 615. The securing element 611 is configured to slidably receive and secure the set of moveable contacts 601 such that the contact pads 607A and 607B disposed thereon can move with a degree of freedom (e.g., in a y-direction). As shown, the support member 615 comprises a half-cylindrical structure defining a bottom portion of the securing element 611. As depicted, the structure of the support member 615 is configured to be complementary to the structure of the body 605 of the set of moveable contacts 601. As depicted, a central body 605 of the set of moveable contacts 601 is configured to be disposed between the extension member 613 and the support member 615 when secured therebetween such that the central body 605 of the moveable contacts 601 is disposed flush between a bottom surface of the extension member 613 and a top surface of the support member 615.

While some of the embodiments herein provide an example set of moveable contacts 601 and a securing element 611, it is noted that the scope of the present disclosure is not limited to such embodiments. For example, in some examples, set of moveable contacts 601 and a securing element 611 in accordance with the present disclosure may be in other forms. In some examples, set of moveable contacts 601 and a securing element 611 may comprise one or more additional and/or alternative elements, and/or may be structured/positioned differently than that illustrated in FIG. 6.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A switching component comprising:
a housing;
a moveable carrier disposed within the housing;
a set of moveable contacts, wherein a central body of the set of moveable contacts is disposed flush between a first surface of the moveable carrier and a second surface of the moveable carrier; and
a set of stationary contacts adjacent the set of moveable contacts, wherein the set of moveable contacts is configured to move with a degree of freedom to make contact with the set of stationary contacts in order to actuate an electrical bridge in response to movement of the moveable carrier.

2. The switching component of claim 1, wherein the set of moveable contacts is attached to the moveable carrier via a securing element.

3. The switching component of claim 1, wherein the central body of the set of moveable contacts comprises an arched configuration having a semi-circular space therebeneath.

4. The switching component of claim 1, wherein the securing element comprises an extension member and a support member.

5. The switching component of claim 4, wherein the set of moveable contacts is disposed between the extension member and the support member.

6. The switching component of claim 4, wherein the support member comprises a half-cylindrical structure configured to complement a space beneath the set of moveable contacts.

7. The switching component of claim 4, wherein the extension member comprises a hook-like appendage protruding from a surface of the moveable carrier.

8. The switching component of claim 7, wherein the extension member further comprises a notch to secure the set of moveable contacts.

9. The switching component of claim 1, wherein:
the set of stationary contacts comprises a first contact pad and a second contact pad, and
the set of moveable contacts comprises a third contact pad adjacent the first contact pad and a fourth contact pad adjacent the second contact pad.

10. The switching component of claim 1, wherein the set of stationary contacts is fixedly attached to a bridge element of the switching component.

11. A switching component comprising:
a housing;
a moveable carrier disposed within the housing;
a first set of moveable contacts, a second set of moveable contacts, a third set of moveable contacts and a fourth set of moveable contacts, wherein a central body of each set of moveable contacts is disposed flush between a first surface of the moveable carrier and a second surface of the moveable carrier; and
a first set of stationary contacts adjacent the first set of moveable contacts, a second set of stationary contacts adjacent the second set of moveable contacts, a third set of stationary contacts adjacent the third set of moveable contacts and a fourth set of stationary contacts adjacent the fourth set of moveable contacts, wherein each set of moveable contacts is configured to move with a degree of freedom to make contact with each adjacent set of stationary contacts in order to actuate an electrical bridge in response to movement of the moveable carrier.

12. The switching component of claim 11, wherein each set of moveable contacts is attached to the moveable carrier via a securing element.

13. The switching component of claim 10, wherein the switching component is configured as a double pole double throw switch.

14. The switching component of claim 10, wherein the central body of each set of moveable contacts comprises an arched configuration having a semi-circular space therebeneath.

15. The switching component of claim 10, wherein each securing element comprises an extension member and a support member.

16. The switching component of claim 15, wherein each set of moveable contacts is disposed between a respective extension member and support member.

17. The switching component of claim 16, wherein each support member comprises a half-cylindrical structure configured to complement a space beneath a respective set of moveable contacts.

18. The switching component of claim 16, wherein each extension member comprises a hook-like appendage protruding from a surface of the moveable carrier.

19. The switching component of claim 18, wherein each extension member further comprises a notch to secure each set of moveable contacts.

20. The switching component of claim 10, wherein each set of stationary contacts is fixedly attached to a bridge element of the switching component.
